(19) United States
(12) Patent Application Publication
(10) Pub. No.: US 2020/0301436 A1
(43) Pub. Date: Sep. 24, 2020

(54) AUTONOMOUS TRAVEL VEHICLE AND ROUTE GENERATION METHOD THEREOF

(71) Applicant: MURATA MACHINERY, LTD., Kyoto-shi (JP)

(72) Inventors: Tsukasa SAKAI, Kyoto (JP); Shinichiro YASUOKA, Tokyo (JP)

(21) Appl. No.: 16/802,779

(22) Filed: Feb. 27, 2020

(30) Foreign Application Priority Data
Mar. 19, 2019 (JP) 2019-051457

(51) Int. Cl. G05D 1/02; A63B 47/02; G01C 21/34

(52) U.S. Cl. CPC G05D 1/0219; A63B 2047/022; G01C 21/343; A63B 47/021

(57) ABSTRACT

A ball collecting and discharging machine plans and travels on an autonomous traveling route in a designated region. A main body includes a travel motor. A ball collecting route travel schedule generator generates a ball collecting route along which the autonomous travel vehicle repeatedly reciprocates in a main direction in a traveling region. A travel controller moves the main body along the ball collecting route by controlling the travel motor. A route generator generates a ball collecting route including lap routes coupled together while shifted in a sub direction intersecting the main direction in the traveling region. Turn-around positions in the main direction of the respective lap routes include at least one set of turn-around positions shifted from each other.

### CROSS REFERENCE TO RELATED APPLICATIONS

This application claims the benefit of priority to Japanese Patent Application No. 2019-051457 filed on Mar. 19, 2019. The entire contents of this application are hereby incorporated herein by reference.

### BACKGROUND OF THE INVENTION

### 1. Field of the Invention

The present invention relates to an autonomous travel vehicle and a route generation method thereof, and in particular, an autonomous travel vehicle that performs an exhaustive travel in an outer circumferential region based on outer circumferential data, and a route generation method thereof.

### 2. Description of the Related Art

The autonomous travel vehicle travels autonomously in accordance with a route plan from a travel start position to a travel end position. The autonomous travel vehicle is used for a device required to travel evenly in a specific region, for example, a cleaning robot and a ball collecting machine in a driving range.

In the case of the cleaning robot, the autonomous travel vehicle executes instruction reproduction travel. During the instruction reproduction travel, the autonomous travel vehicle travels based on a traveling route instructed in advance by a worker.

The instruction reproduction travel includes, as an example, a copy travel in which all the traveling routes are instructed by the worker operation in advance and the autonomous travel vehicle reproduces the traveling routes as they are.

The instruction reproduction travel includes, as an example, an exhaustive travel in which an outer circumference is instructed by a user operation and the autonomous travel vehicle creates and executes an exhaustive route plan in the outer circumference (see International Publication No. 2018/043180), for example.

In the case of the exhaustive travel of the autonomous travel vehicle, if the exhaustive route plan is created and executed using the same outer circumferential data, the generated route is always constant. Therefore, in the case of a cleaning machine, wheel marks remain on the floor surface. In the case of a ball collecting machine on a golf course, the lawn or grass where the wheel passes is rutted or shaved.

International Publication No. 2018/043180 discloses a route creation method with which a traveling route is changed for each execution of autonomous traveling or each predetermined number of times.

However, in the case of a towing vehicle such as a ball collecting machine or a four-wheel vehicle, the minimum turning radius is large, and hence an untraveled area (which is an area that should be traveled but has not actually been traveled) always occurs when the vehicle body is rotated by 180 degrees. Then, it is conceivable to create a route along which the vehicle repeatedly travels while shifting a plurality of lap routes. In this case, since the turn-around portions of the lap routes overlap a plurality of times, it is assumed that a portion of the lawn or grass is damaged.

### SUMMARY OF THE INVENTION

Preferred embodiments of the present invention reduce or prevent overlapping travel areas while reducing an untraveled area in an autonomous travel vehicle that performs an exhaustive travel.

Hereinafter, a plurality of aspects of preferred embodiments of the present invention will be described. These aspects may be combined in any manner where necessary.

An autonomous travel vehicle according to an aspect of a preferred embodiment of the present invention plans and travels an autonomous traveling route in a designated region, and includes a main body, a route generator, and a travel controller.

The main body has a conveyor.

The route generator generates an autonomous traveling route along which the autonomous travel vehicle reciprocates a plurality of times in a main direction in the designated region.

The travel controller moves the main body along the autonomous traveling route by controlling the conveyor.

The route generator generates an autonomous traveling route including a plurality of lap routes coupled while being shifted in a sub direction intersecting the main direction in the region.

Turn-around positions in the main direction of the lap routes include at least one set of turn-around positions shifted from each other.

The autonomous travel vehicle travels on an autonomous traveling route in the region. The autonomous traveling route is including the plurality of lap routes coupled while being shifted in the sub direction intersecting the main direction. Therefore, the untraveled area is able to be reduced even if the autonomous travel vehicle has a large minimum turning radius. Furthermore, since the turn-around positions in the main direction of the respective lap routes include at least one set of turn-around positions shifted from each other, overlapping travel areas at the turn-around positions are reduced.

A turn-around position of a last lap route in the region may be on a travel direction innermost side in the main direction among a plurality of turn-around positions. The autonomous travel vehicle reduces the untraveled area in the last lap route.

A turn-around position of a first lap route in the region may be on the travel direction innermost side in the main direction among a plurality of turn-around positions.

The autonomous travel vehicle reduces the untraveled area in the first lap route.

The shift of the turn-around position may be equal to or greater than the wheel width of the conveyor.

In the autonomous travel vehicle, since the shift of the turn-around position is sufficiently large, overlap of the lap routes at the turn-around positions hardly occurs.

In route generation after the first time, the route generator may set the main direction of a lap route with respect to the region at an angle different from the main direction of a lap route created last time.

In the autonomous travel vehicle, since the angles of the main direction of the lap routes are different in the respective route generations, overlapping travel areas with the route generated last time are reduced.

In route generation after the first time, the route generator may shift a lap route in the sub direction and/or the main direction with respect to a lap route created last time.

In the autonomous travel vehicle, since the lap routes are shifted in the respective route generations, overlapping travel areas are reduced.

In route generation after the first time, the route generator may set the width in the sub direction of the lap route to a length different from the width in the sub direction of the lap route created last time.

In the autonomous travel vehicle, since the widths in the sub direction of the lap routes are different in the respective route generations, overlapping travel areas with the route generated last time are reduced.

In order to generate the plurality of lap routes, the route generator may divide the region into 2N (N is a natural number) main direction routes in the sub direction so as to be in a long strip shape in the main direction, determine a travel order in the main direction routes as a first, an N+1-th, a second, and an N+2-th, and set travel directions of the main direction routes from the first to a N-th and from the N+1-th to a 2N-th so as to be opposite to each other.

In the autonomous travel vehicle, the route generation by the route generator can be achieved with a small calculation amount.

A method according to another aspect of a preferred embodiment of the present invention is a route generation method for an autonomous travel vehicle that plans and travels an autonomous traveling route in a designated region, including generating a route along which the autonomous travel vehicle reciprocates a plurality of times in the main direction in the designated region, the route being an autonomous traveling route including a plurality of lap routes coupled together while being shifted in the sub direction.

Turn-around positions in a main direction of the respective lap routes include at least one set of turn-around positions shifted from each other.

According to the route generation method, the autonomous travel vehicle travels on an autonomous traveling route including a plurality of lap routes coupled together while being shifted in the sub direction intersecting the main direction in the region. Therefore, the untraveled area is able to be reduced even if the autonomous travel vehicle has a large minimum turning radius. Furthermore, since the turn-around positions in the main direction of the respective lap routes include at least one set of turn-around positions shifted from each other, overlapping travel areas at the turn-around positions are reduced or prevented.

The autonomous travel vehicle that performs an exhaustive travel and the route generation method thereof according to a preferred embodiment of the present invention, it is possible to reduce overlapping travel areas while reducing untraveled area.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic plan view of a driving range.

FIG. 2 is a schematic perspective view of a ball collecting and discharging machine.

FIG. 3 is a schematic perspective view of the ball collecting and discharging machine.

FIG. 4 is a block diagram illustrating an overall configuration of a controller.

FIG. 5 is a schematic plan view of the ball collecting and discharging machine.

FIG. 6 is a schematic plan view illustrating turn-around traveling of the ball collecting and discharging machine.

FIG. 7 is a flowchart illustrating a control operation of a manual operation instruction mode of exhaustive travel.

FIG. 8 is a flowchart illustrating details of steps of creating a ball collecting route travel schedule.

FIG. 9 is a schematic view illustrating in a stepwise manner a state in which a ball collecting route is created in a traveling region.

FIG. 10 is a schematic view illustrating in a stepwise manner a state in which the ball collecting route is created in the traveling region.

FIG. 11 is a schematic view illustrating in a stepwise manner a state in which the ball collecting route is created in the traveling region.

FIG. 12 is a schematic view illustrating in a stepwise manner a state in which the ball collecting route is created in the traveling region.

FIG. 13 is a schematic plan view illustrating the ball collecting route in the traveling region.

FIG. 14 is a schematic plan view illustrating a lap route of the ball collecting route.

FIG. 15 is a schematic plan view illustrating the lap route of the ball collecting route.

FIG. 16 is a schematic plan view illustrating a position relationship between turn-around routes of the lap route.

FIG. 17 is a schematic plan view of the present preferred embodiment of the present invention in which a turn-around position is shifted.

FIG. 18 is a schematic plan view of a conventional example in which the turn-around position is not shifted.

FIG. 19 is a schematic plan view illustrating the ball collecting route in the traveling region according to a second preferred embodiment of the present invention.

FIG. 20 is a schematic plan view illustrating the ball collecting route in the traveling region according to a third preferred embodiment of the present invention.

FIG. 21 is a schematic plan view illustrating the ball collecting route in the traveling region according to a fourth preferred embodiment of the present invention.

FIG. 22 is a schematic plan view illustrating the ball collecting route in the traveling region according to a fifth preferred embodiment of the present invention.

### DETAILED DESCRIPTION OF THE PREFERRED EMBODIMENTS

### 1. First Preferred Embodiment

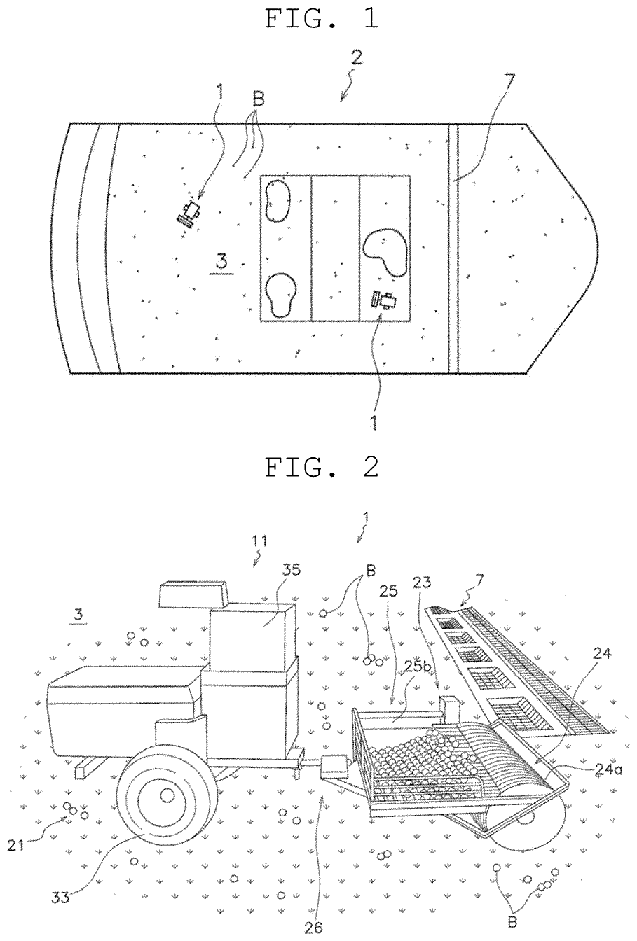

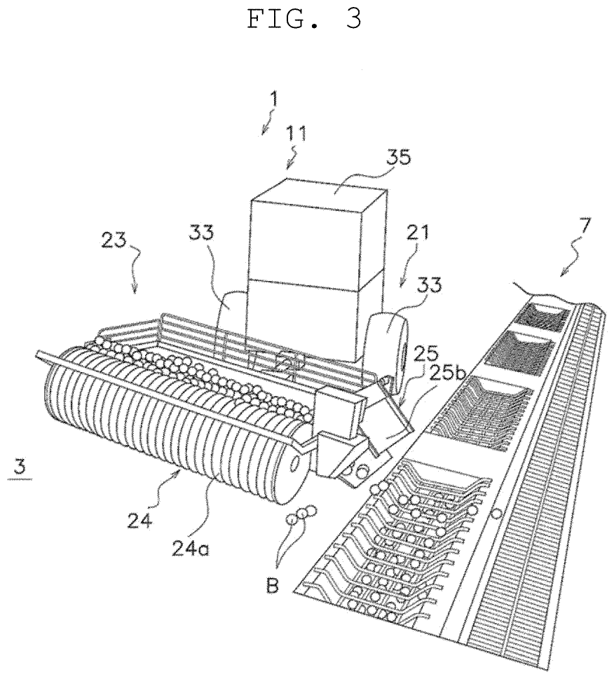

A ball collecting and discharging machine 1 will be described with reference to FIGS. 1 to 3. FIG. 1 is a schematic plan view of a driving range. FIGS. 2 and 3 are schematic perspective views of the ball collecting and discharging machine.

In the present preferred embodiment, the ball collecting and discharging machine 1 is used in a driving range 2 (an example of ball collecting and discharging section). This is because a large number of golf balls B are scattered in a short period of time in the driving range 2, and it is necessary to collect and reuse scattered golf balls B.

The driving range 2 includes a ball scattered area 3, in which the plurality of golf balls B are scattered, and a ball discharging site 7, in which the collected golf balls B are discharged. In this preferred embodiment, the ball scattered area 3 is turfed. The ball discharging site 7 is a groove provided in the ball scattered area 3. The golf balls B delivered to the ball discharging site 7 are sent to a collection pool by discharged water.

The ball collecting and discharging machine 1 is a device that collects and discharges balls by performing instruction reproduction travel in the driving range 2. The term “instruction reproduction travel” is a travel based on a route having been instructed in advance by the worker, and includes, for example, a copy travel, which is to travel on the traveling route itself having been instructed in advance by the worker, and an exhaustive travel in which the controller determines an autonomous traveling route within a frame having been instructed in advance by the worker.

The ball collecting and discharging machine 1 includes a main body 11, a storage 13, and a controller 15.

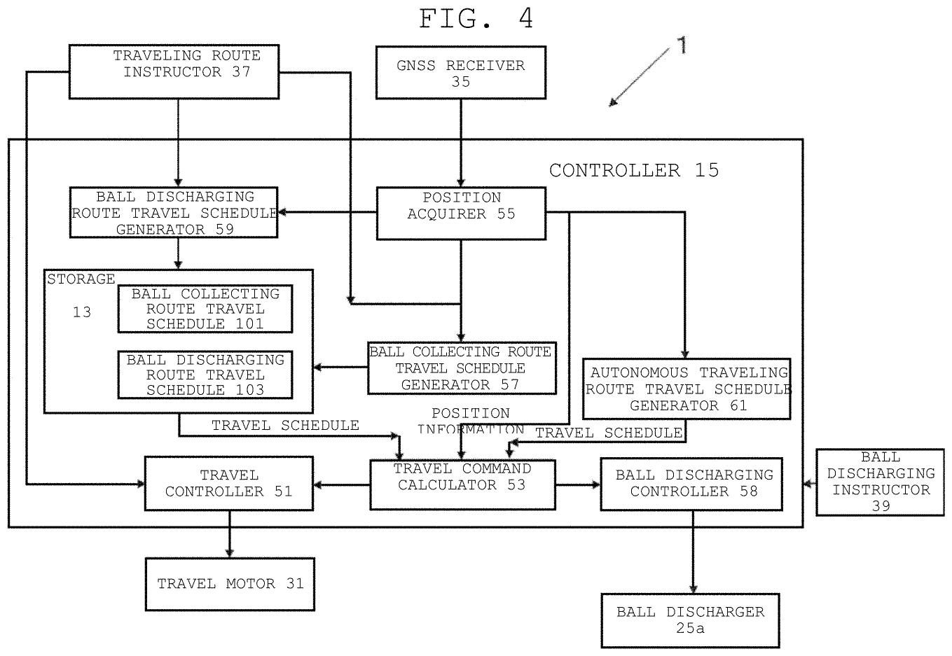

The main body 11 includes a conveyor 21, and a ball collector and discharger 23 capable of collecting the golf balls B and discharging the golf balls B. Specifically, the conveyor 21 is a device that causes the ball collecting and discharging machine 1 to travel. The conveyor 21 includes, for example, a travel motor (FIG. 4) provided in the main body 11, and wheels 33.

The ball collecting and discharging machine 1 includes a GNSS (Global Navigation Satellite System) receiver 35 provided in the main body 11. The GNSS receiver 35 acquires information (position information) on a current position of the ball collecting and discharging machine 1 on the ground. As a result, the ball collecting and discharging machine 1 is capable of traveling outdoors while grasping its own position.

The ball collecting and discharging machine 1 may include a geomagnetic sensor (not illustrated) provided in the main body 11. The geomagnetic sensor measures an orientation of geomagnetism at the position of the ball collecting and discharging machine 1 (the main body 11) in the driving range 2. Due to this, it is possible to measure the direction in which the ball collecting and discharging machine 1 (the main body 11) is facing in the driving range 2.

In addition, a pair of the GNSS receivers 35 may be provided in the main body 11. For example, the pair of GNSS receivers 35 are arranged side by side on a predetermined axis (e.g., an axis parallel or substantially parallel to the straight-traveling direction of the ball collecting and discharging machine 1) of the main body 11. Due to this, the orientation (direction) of the main body 11 in the driving range 2 can be calculated from two coordinate values (combination of latitude and longitude) obtained from the pair of GNSS receivers 35 (Moving Baseline method). As a result, by calculating the direction using the coordinates obtained by the GNSS receivers 35, the direction of the ball collecting and discharging machine 1 can be easily measured (calculated) without performing calibration for each place of use.

The ball collector and discharger 23 includes a ball collector 24 to collect the golf balls B and a ball discharger 25 to discharge the golf balls B. The ball collector 24 performs a publicly known technique and includes a pickup rotor 24a that rotates along with the travel of the main body 11. It is to be noted that the ball collector 24 may have a configuration in which the pickup rotor 24a rotates by a ball collector motor (not illustrated). The ball discharger 25 performs a publicly known technique and has a ball discharger motor 25a (FIG. 4) and a ball discharging gate 25b driven by the ball discharger motor 25a.

As an alternative preferred embodiment, the ball collector and discharger 23 may include a ball storage amount detector (not illustrated). When the storage amount of the balls exceeds the threshold value in the storage amount detector, the balls become ready to be discharged. Specifically, the storage amount detector is, for example, a weight sensor measuring the weight of the stored golf balls B or a photoelectric sensor detecting the height of the upper surface of the stored golf balls B.

The storage 13 is provided in the controller 15 in this preferred embodiment. The storage 13 is a portion of or an entirety of a storage region of a storage device of a computer system defining the controller 15, and stores various types of information related to the ball collecting and discharging machine 1. The storage 13 stores a ball collecting route travel schedule 101 and a ball discharging route travel schedule 103, for example, as will be described later.

The controller 15 is a computer system including a CPU, a storage device (RAM, ROM, hard disk drive, SSD, or the like) and various types of interfaces. The controller 15 performs these various types of controls related to the ball collecting and discharging machine 1.

The configuration of the controller 15 will be described in detail with reference to FIG. 4. FIG. 4 is a block diagram illustrating an overall configuration of the controller. All or some of functional blocks of the controller 15 described below may be implemented by a program executable by a computer system defining the controller 15. In this case, the program may be stored in a memory and/or the storage. All or some of the functional blocks of the controller 15 may be implemented as a custom IC such as an SoC (System on Chip).

The controller 15 may be defined by a single computer system or may be defined by a plurality of computer systems. When the controller 15 is defined by a plurality of computer systems, for example, functions carried out by a plurality of functional blocks can be executed by allocating the functions to the plurality of computer systems at any ratio.

The controller 15 includes a travel controller 51. The travel controller 51 controls the travel motor 31. The travel controller 51 receives a travel command from a travel command calculator 53 (described later). The travel controller 51 receives a travel command from a traveling route instructor 37 in an instructed travel mode. The traveling route instructor 37 is, for example, an operator that operates the ball collecting and discharging machine 1, such as a steering wheel. That is, the travel controller 51 receives the operation of the worker through the traveling route instructor 37.

The controller 15 includes the travel command calculator 53. The travel command calculator 53 outputs a travel command to the travel controller 51. Data provided to the travel command calculator 53 is the ball collecting route travel schedule 101 in an exhaustive travel mode and the ball discharging route travel schedule 103 in a copy travel mode. The travel controller 51 calculates a target rotation speed of the travel motor 31, and outputs, to the travel motor 31, drive power to rotate the travel motor 31 at the target rotation speed.

The controller 15 includes a ball discharging controller 58. The ball discharging controller 58 controls the ball discharger motor 25a.

The controller 15 includes a position acquirer 55. The position acquirer 55 acquires position information acquired by the GNSS receiver 35. As a result, the controller 15 can grasp which position in the ball scattered area 3 the ball collecting and discharging machine 1 is moving. Specifically, the position acquirer 55 receives absolute coordinates (latitude/longitude) of the current location obtained by RTK (Real Time Kinematic) positioning.

The controller 15 includes a ball collecting route travel schedule generator 57. The ball collecting route travel schedule generator 57 creates the ball collecting route travel schedule 101 described above. The ball collecting route travel schedule 101 is a schedule in which the ball collecting and discharging machine 1 travels evenly (as if “filling”) in a traveling region TA. The traveling region TA is a region in which the ball collecting and discharging machine 1 travels in a travel environment.

When the manual operation instruction mode is executed, the ball collecting route travel schedule generator 57 receives position information having been input from the position acquirer 55 at a predetermined length of time (e.g., every control cycle in the controller 15). Due to this, the ball collecting route travel schedule generator 57 acquires a point sequence of a plurality of pieces of position information, and determines the traveling region TA based on the acquired point sequence of the plurality of pieces of position information.

Next, the ball collecting route travel schedule generator 57 creates the ball collecting route travel schedule 101 in the traveling region TA, and stores the same in the storage 13.

The controller 15 includes a ball discharging route travel schedule generator 59. The ball discharging route travel schedule generator 59 creates the ball discharging route travel schedule 103 based on the rotation amount and rotation direction of the steering wheel having been input from the traveling route instructor 37 in the instructed travel mode. The ball discharging route travel schedule 103 is a set of passing time in the instructed travel mode and passing point data corresponding to the passing time, and indicates the traveling route in which the ball collecting and discharging machine 1 autonomously moves at the time of execution of the reproduction travel mode. At the time of execution of the reproduction travel mode, the ball collecting and discharging machine 1 controls the travel motor 31 so as to reach the target position with reference to the target position indicated in the ball discharging route travel schedule 103. In this preferred embodiment, the ball discharging route travel schedule 103 is a travel schedule of a ball discharging route (not illustrated), which is a copy traveling route having been instructed in advance by the worker, and at least a portion of the ball discharging route is in a vicinity of the ball discharging site 7.

With the above configuration, the travel command calculator 53 calculates a control command (reproduction travel control command) for autonomous travel on the traveling route indicated in the ball collecting route travel schedule 101 or the ball discharging route travel schedule 103 as reproduction travel control at the time of execution of an autonomous travel mode, and outputs the control command to the travel controller 51. The travel command calculator 53 calculates the reproduction travel control command based on the information stored in the schedule and the position information acquired from the position acquirer 55.

Due to this, at the time of execution of the autonomous travel mode, the travel controller 51 is capable of autonomously moving the ball collecting and discharging machine 1 by controlling the travel motor 31 based on the reproduction travel control command.

The controller 15 includes a ball discharging instructor 39. The ball discharging instructor 39 is, for example, an operation panel including a press button, and the ball discharging instructor 39 transmits, for example, the operation of the press button by the operator to the ball discharging controller 58.

The ball discharging controller 58 receives a button operation from the ball discharging instructor 39 and converts the operation into a ball collecting instruction or a ball discharging instruction. The ball discharging controller 58 drives the ball discharging gate 25b by outputting the ball discharging instruction to the ball discharger motor 25a.

Ball collecting conditions and ball discharging conditions are stored by the travel command calculator 53 in association with the ball collecting route travel schedule 101 and the ball discharging route travel schedule 103, respectively.

At the time of execution of the autonomous travel mode, based on the ball discharging conditions associated with the ball discharging route travel schedule 103, the ball discharging controller 58 controls the ball discharger motor 25a and opens the ball discharging gate 25b. Due to this, the ball collecting and discharging machine 1 is capable of autonomously executing the ball collecting work and the ball discharging work in accordance with the ball discharging conditions during autonomous traveling.

The controller 15 includes an autonomous traveling route travel schedule generator 61.

If the position information of the start point and the end point is obtained, the autonomous traveling route travel schedule generator 61 calculates an optimal travel schedule, and creates an autonomous traveling route travel schedule. The route generation algorithm is publicly known and is not particularly limited.

In the autonomous traveling route travel mode, the travel command calculator 53 transmits a travel command to the travel controller 51 based on the autonomous traveling route travel schedule.

Although not illustrated, a sensor and a switch to detect the state of each device, and an information input device are connected to the controller 15.

An encoder (not illustrated) is attached to an output rotation shaft of the travel motor 31, for example.

Furthermore, a front detector and a rear detector (not illustrated) are attached to the main body 11. These are laser range finders (LRF) having a detection range of 180° or more. The front detector and the rear detector may include TOF (Time Of Flight) cameras or the like.

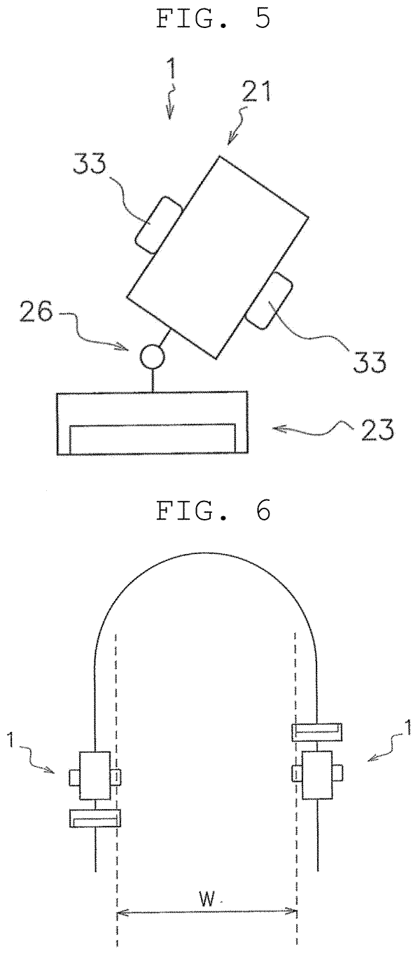

With reference to FIGS. 5 and 6, the travel characteristics of the ball collecting and discharging machine 1 will be described. FIG. 5 is a schematic plan view of the ball collecting and discharging machine. FIG. 6 is a schematic plan view illustrating turn-around traveling of the ball collecting and discharging machine.

As mentioned above, the ball collector and discharger 23 is coupled to the conveyor 21 by a towing structure 26, and the minimum radius at the time of rotation is large. Accordingly, when the ball collecting and discharging machine 1 performs turn-around traveling, as illustrated in FIG. 6, a large gap W is formed between the forward route and the return route.

One solution for the above problem is to create a traveling route connecting a plurality of lap routes to each other by shifting the lap routes laterally.

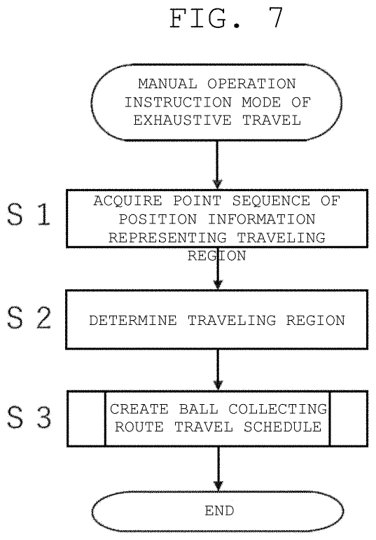

With reference to FIG. 7, the manual operation instruction mode of exhaustive travel will be described. FIG. 7 is a flowchart illustrating a control operation of the manual operation instruction mode of exhaustive travel.

The control flowchart described below is an example, and each step can be omitted or replaced as necessary. A plurality of steps may be executed simultaneously, or some or all of the steps may be executed in an overlapping manner.

Furthermore, each block of the control flowchart is not limited to a single control operation, but can be replaced by a plurality of control operations represented by a plurality of blocks.

The operation of each device is a result of a command from the controller to each device, which is represented by each step of a software application.

In step S1, the ball collecting route travel schedule generator 57 acquires a point sequence (coordinate value) of position information representing the traveling region TA at the time of execution of the manual operation instruction mode.

In step S2, the ball collecting route travel schedule generator 57 determines the traveling region TA.

In step S3, the ball collecting route travel schedule generator 57 creates the ball collecting route travel schedule 101 including an exhaustive route in the traveling region TA, and stores the same in the storage 13.

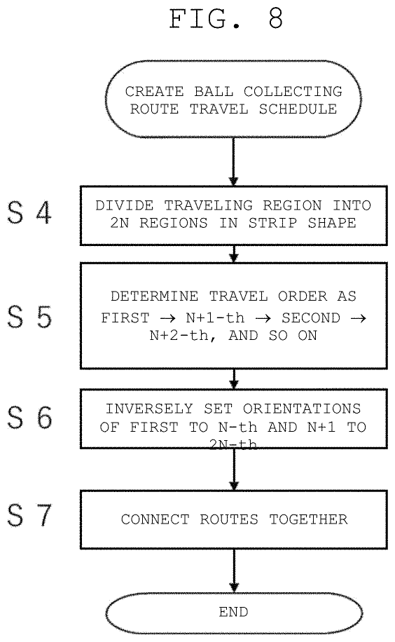

Step S3 of FIG. 4 will be described in detail with reference to FIGS. 8 to 12. FIG. 8 is a flowchart illustrating details of steps of creating the ball collecting route travel schedule. FIGS. 9 to 12 are schematic views illustrating in a stepwise manner a state in which the ball collecting route is created in the traveling region.

In step S4, as illustrated in FIG. 9, the ball collecting route travel schedule generator 57 divides the region into 2N regions in a strip shape. At this time, the longitudinal direction of each region is the main direction, and a direction orthogonal thereto is the sub direction. At this time, the width of the divided region is set to be equal to or less than the width of the ball collector and discharger 23.

In step S5, as illustrated in FIG. 10, the ball collecting route travel schedule generator 57 determines a travel order of the divided regions such as the first region, the N+1-th region, the second region, the N+2-th region, and so on.

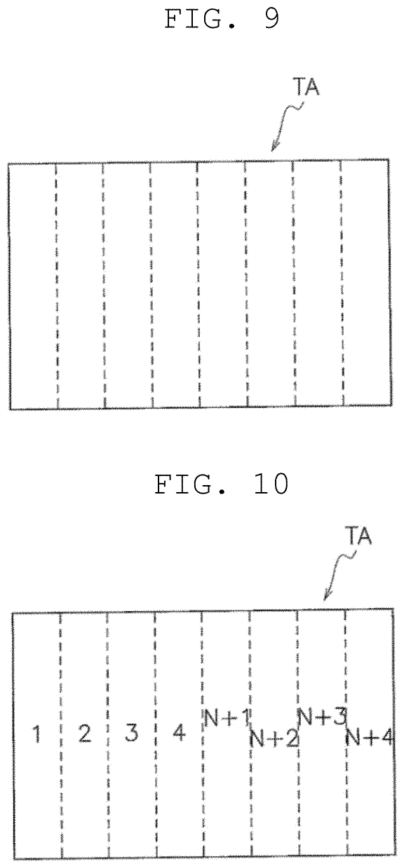

In step S6, as illustrated in FIG. 11, the ball collecting route travel schedule generator 57 sets a traveling route in each of the 2N regions. In this case, the travel direction of the first to N-th regions and the travel direction of the N+1 to 2N-th regions are set inversely.

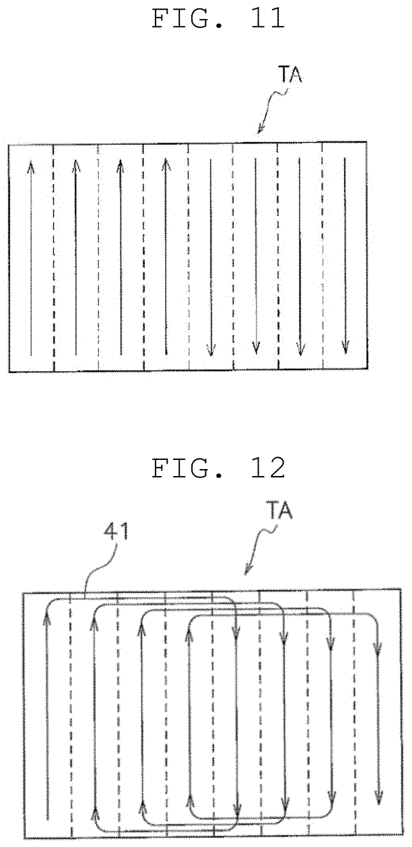

In step S7, as illustrated in FIG. 12, the routes are connected each other. Specifically, the end point of the m (1, 2, . . . N-1)-th traveling route and the start point of the m+N-th traveling route are connected together, and the end point of the m+N-th traveling route and the start point of the m+1 traveling route are connected together. This connection operation is repeated by incrementing m by one from 1 to N-1.

Furthermore, the end point of the N-th traveling route and the start point of the 2N-th traveling route are connected together, after that the end point of the 2N-th traveling route and the start point of the first traveling route are connected together, and generation of the partial traveling route is finished.

When the two traveling routes are connected as described above, as illustrated in FIG. 12, a 90° curve is provided on a connecting line of the two traveling routes. The radius of this curve is set to be equal to or greater than the minimum radius at the time of rotation of the ball collecting and discharging machine 1.

The number of regions divided to provide a ball collecting route may be 2N+1 (odd number).

In addition, in order to provide the ball collecting route, one lap route may be created first and reused.

The outline of the ball collecting route will be described with reference to FIG. 13. FIG. 13 is a schematic plan view illustrating the ball collecting route in the traveling region.

The ball collecting route travel schedule generator 57 generates a ball collecting route 41 including a plurality of lap routes (specifically, 63A to 63F) coupled together while shifted in the sub direction intersecting the main direction in the traveling region TA in the ball scattered area 3.

The positions (turn-around positions) of the main direction of turn-around portions (specifically, 64b to 69b and 64d to 69d) in the main direction of the respective lap routes include at least one set of turn-around positions shifted from each other (described in detail later).

The ball collecting and discharging machine 1 travels on the ball collecting route 41 including the plurality of lap routes coupled together while shifted in the sub direction intersecting the main direction in the traveling region TA in the ball scattered area 3. Therefore, the untraveled area can be reduced even if the ball collecting and discharging machine has a large minimum turning radius. Furthermore, the turn-around positions in the main direction of the respective lap routes include at least one set of turn-around positions shifted from each other. Accordingly, overlapping travel areas at the turn-around positions are reduced.

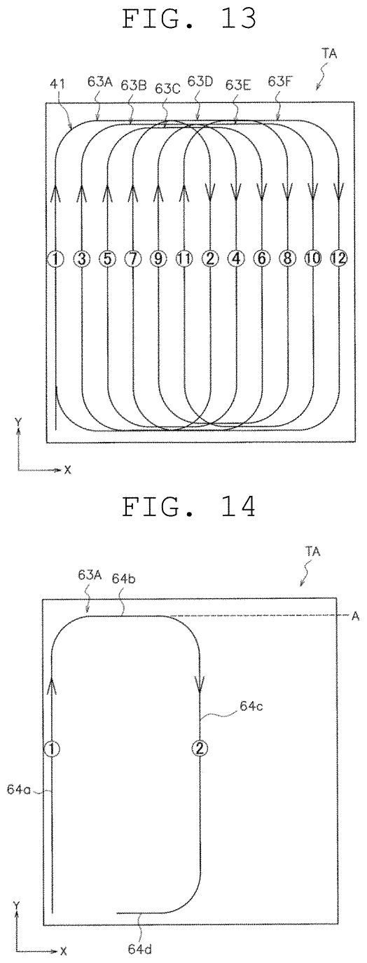

The ball collecting route 41 will be described in detail with reference to FIGS. 13, 14, and 15. FIGS. 14 and 15 are schematic plan views illustrating the lap route of the ball collecting route. Note that in this preferred embodiment, the main direction of the ball collecting route 41 is the orientation of an arrow Y and the sub direction is the orientation of an arrow X. The orientations of the arrows X and Y are orthogonal.

As illustrated in FIG. 13, the ball collecting route 41 is an exhaustive traveling route along which the vehicle travels over the entire area inside the traveling region TA, and the ball collecting route 41 has a first lap route 63A, a second lap route 63B, a third lap route 63C, a fourth lap route 63D, a fifth lap route 63E, and a sixth lap route 63F.

In FIG. 13, the travel order in the main direction route of the respective lap routes is indicated by encircled numbers in the entire ball collecting route 41.

Hereinafter, the first lap route 63A and the second lap route 63B will be described in detail. However, the third lap route 63C, the fourth lap route 63D, the fifth lap route 63E, and the sixth lap route 63F are similar, and thus the description thereof will be omitted.

As illustrated in FIG. 14, the first lap route 63A includes a first main direction route 64a, a first turn-around route 64b, a second main direction route 64c, and a second turn-around route 64d in a continuous manner. The first main direction route 64a and the second main direction route 64c extend in the main direction. The first turn-around route 64b and the second turn-around route 64d extend in the sub direction. The first turn-around route 64b and the second turn-around route 64d are positioned on the outermost side where traveling is possible in the main direction.

As illustrated in FIG. 15, the second lap route 63B includes a first main direction route 65a, a first turn-around route 65b, a second main direction route 65c, and a second turn-around route 65d in a continuous manner. The first main direction route 65a and the second main direction route 65c extend in the main direction. The first turn-around route 65b and the second turn-around route 65d extend in the sub direction.

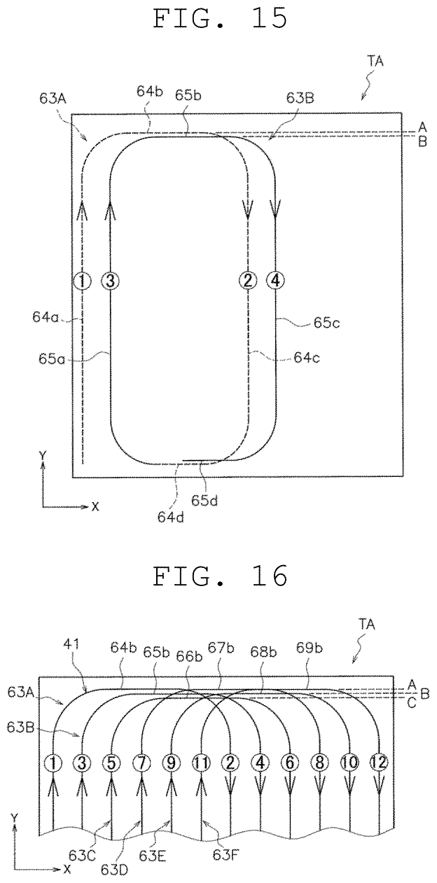

With reference to FIG. 16, the position relationship between the turn-around routes on the upper side of the lap route on the drawing will be described. FIG. 16 is a schematic plan view illustrating the position relationship between the turn-around routes of the lap route. The same is true for the lower side in FIG. 16, and hence the description thereof will be omitted.

The first turn-around route 64b of the first lap route 63A is at the farthest first position A. That is, the first turn-around route 64b is on the outermost side in the main direction.

The first turn-around route 65b of the second lap route 63B is shifted in the main direction with respect to the first turn-around route 64b, and specifically, it is at a second position B shifted inwards in the main direction.

A first turn-around route 66b of the third lap route 63C is shifted in the main direction with respect to the first turn-around route 65b, and specifically, it is at a third position C shifted inwards in the main direction.

A first turn-around route 67b of the fourth lap route 63D is shifted in the main direction with respect to the first turn-around route 66b, and specifically, it is at the first position A shifted outwards in the main direction. The first turn-around route 67b is arranged on the outermost side in the main direction.

A first turn-around route 68b of the fifth lap route 63E is shifted in the main direction with respect to the first turn-around route 67b, and specifically, it is at the second position B shifted inwards in the main direction.

A first turn-around route 69b of the sixth lap route 63F is shifted in the main direction with respect to the first turn-around route 68b, and specifically, it is at the first position A shifted outwards in the main direction. That is, the first turn-around route 69b is on the outermost side in the main direction.

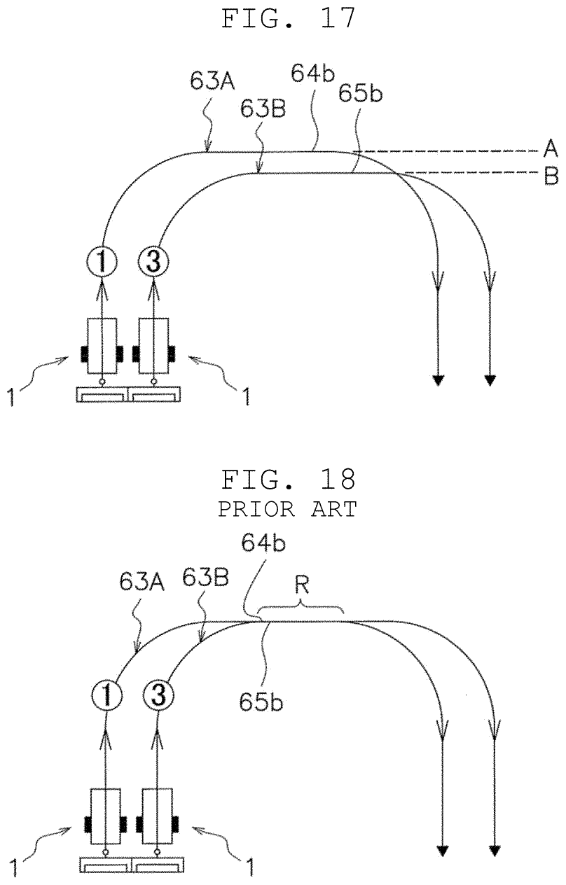

With reference to FIGS. 17 and 18, a difference in effect between when the turn-around position is shifted and when the turn-around position is not shifted will be described in detail. FIG. 17 is a schematic plan view of the present preferred embodiment in which the turn-around position is shifted. FIG. 18 is a schematic plan view of a conventional example in which the turn-around position is not shifted.

As illustrated in FIG. 17, the first turn-around route 65b of the second lap route 63B is shifted in the main direction with respect to the first turn-around route 64b of the first lap route 63A, and specifically, it is shifted inwards in the main direction. Accordingly, overlapping travel areas at the turn-around positions of the lap routes are reduced.

As described above, by changing the turn-around position of the lap route of the ball collecting route 41 generated based on the outer circumferential data, the position at which the wheels move can be shifted, and as a result, damage to the lawn can be reduced, for example.

As illustrated in FIG. 18, as an example different from the present preferred embodiment, the first turn-around route 65b of the second lap route 63B is not shifted in the main direction with respect to the first turn-around route 64b of the first lap route 63A. Accordingly, in this ball collecting and discharging machine, an overlapping travel area R at the turn-around position becomes long. The above is a conventional example assumed as an example in which the problem to be solved by the present preferred embodiment arises.

The turn-around position of the sixth lap route 63F, which is the last lap route in the traveling region TA, is the first turn-around position A. The first turn-around position A is on the travel direction innermost side in the main direction among the plurality of turn-around positions A to C. Due to this, the ball collecting and discharging machine 1 reduces the untraveled area in the sixth lap route 63F.

This characteristic is not essential and can be omitted.

The turn-around position of the first lap route 63A, which is the first lap route in the traveling region TA, is the first turn-around position A. The first turn-around position A is on the travel direction innermost side in the main direction among the plurality of turn-around positions A to C. Due to this, the ball collecting and discharging machine 1 reduces the untraveled area in the first lap route 63A.

This characteristic is not essential and can be omitted.

The shift of the turn-around position may be equal to or greater than the width of the wheels 33 of the conveyor 21. Due to this, in the ball collecting and discharging machine 1, since the shift of the turn-around position is sufficiently large, overlap of the lap routes at the turn-around positions hardly occurs.

In this preferred embodiment, the shift of the turn-around position is set so as to always occur between continuous lap routes. It is seen in, as illustrated in FIG. 17, for example, a case of the turn-around route 64b of the first lap route 63A and the turn-around route 65b of the second lap route 63B. It is because a long overlapping travel region is provided when the turn-around routes of the continuous lap routes overlap each other, and it is preferable to avoid formation of a long overlapping travel region.

A shift amount at the turn-around position of a certain ball collecting route may be made different from the shift amount of the turn-around position of the previous ball collecting route.

### 2. Second Preferred Embodiment

In the first preferred embodiment, the route generation of a single exhaustive travel is described. In reality, exhaustive travel is performed for a plurality of times. Then, the route generation after the first time that is a route generation in which an overlapping travel area is reduced by making a change to the last or past exhaustive travel will be described in the following second to fifth preferred embodiments.

In the second preferred embodiment, the ball collecting and discharging machine may travel after creating the exhaustive route each time the traveling route is set, or may travel after appropriately selecting one or more among a plurality of patterns of exhaustive routes formed in advance (the same is true for the following other preferred embodiments).

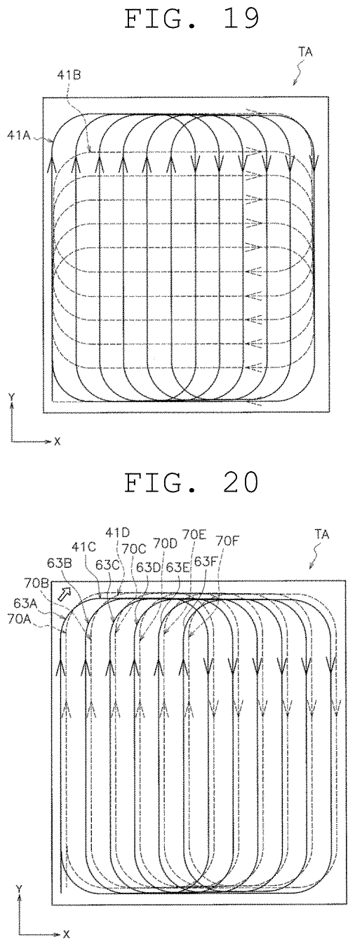

The second preferred embodiment will be described with reference to FIG. 19. FIG. 19 is a schematic plan view illustrating the ball collecting route in the traveling region according to the second preferred embodiment.

In route generation after the first time, the ball collecting route travel schedule generator 57 sets the main direction of the lap route with respect to the traveling region TA at an angle different from the main direction of the lap route created last time. Due to this, since the angles of the main direction of the lap routes are different in the respective route generations, overlapping travel areas are reduced.

In FIG. 19, a first ball collecting route 41A created in the first time for example is indicated by a solid line, and a second ball collecting route 41B created in the second time for example is indicated by a broken line. The main direction of the lap route of the second ball collecting route 41B is set at an angle different from the main direction of the lap route of the first ball collecting route 41A. In this preferred embodiment, the angle is 90 degrees. Specifically, the main direction of the first ball collecting route 41A is the orientation of the arrow Y and the sub direction is the orientation of the arrow X, meanwhile the main direction of the second ball collecting route 41B is the orientation of the arrow X and the sub direction is the orientation of the arrow Y.

As described above, the main direction of an exhaustive travel (the direction in which the length of the straight line becomes longest) is changed with respect to the last or past exhaustive traveling route. Accordingly, overlapping travel areas in the ball collecting routes are reduced.

The above angle is any angle appropriately selectable from a range of about 45 degrees to about 135 degrees, for example.

The angle change may be made for each ball collecting route creation, or ball collecting route creation without changing the angle may be carried out continuously.

Furthermore, although not illustrated in FIG. 19, in each ball collecting route, the turn-around position of the lap route may be shifted as in the first preferred embodiment. For example, the turn-around positions of the lap route may be shifted in the entire respective ball collecting routes, or the turn-around positions of the lap route may be shifted only in some ball collecting routes.

### 3. Third Preferred Embodiment

The third preferred embodiment will be described with reference to FIG. 20. FIG. 20 is a schematic plan view illustrating the ball collecting route in the traveling region according to the third preferred embodiment.

The ball collecting route travel schedule generator 57 generates a fourth ball collecting route 41D so as to shift the lap route of the fourth ball collecting route 41D to the sub direction (e.g., the orientation of the arrow X) and/or the main direction (e.g., the orientation of the arrow Y) with respect to the lap route of a third ball collecting route 41C created last time. Due to this, since the lap routes of the ball collecting route are shifted in the respective route generations, overlapping travel areas are reduced.

As illustrated in FIG. 20, the third ball collecting route 41C includes the first lap route 63A, the second lap route 63B, the third lap route 63C, the fourth lap route 63D, the fifth lap route 63E, and the sixth lap route 63F.

As illustrated in FIG. 20, the fourth ball collecting route 41D includes a first lap route 70 A, a second lap route 70B, a third lap route 70C, a fourth lap route 70D, a fifth lap route 70E, and a sixth lap route 70F.

The fourth ball collecting route 41D preferably includes the lap routes in the same number, the same shape, the same orientation, and the same dimensions as those of the third ball collecting route 41C. In the fourth ball collecting route 41D, the lap routes are shifted in the sub direction and the main direction, and specifically, they are shifted to diagonally right in the drawing.

As described above, since the exhaustive route is shifted with respect to the last or past exhaustive traveling route, overlapping travel areas in the ball collecting routes are reduced.

The fourth ball collecting route 41D may be shifted only in the main direction or only in the sub direction with respect to the third ball collecting route 41C.

The above shift may be performed for each ball collecting route creation, or ball collecting route formation without forming the shift may be carried out continuously.

Furthermore, although not illustrated in FIG. 20, in each ball collecting route, the turn-around position of the lap route may be shifted as in the first preferred embodiment. For example, the turn-around positions of the lap route may be shifted in the entire respective ball collecting routes, or the turn-around positions of the lap route may be shifted only in some ball collecting routes.

### 4. Fourth Preferred Embodiment

In route generation of a sixth ball collecting route 41F, the ball collecting route travel schedule generator 57 sets the width in the sub direction of the sixth ball collecting route 41F (e.g., the orientation of the arrow X) to a length different from the width in the sub direction of a fifth ball collecting route 41E created previously. Due to this, since the widths in the sub direction of the lap routes are different in the respective route generations, overlapping travel areas are reduced.

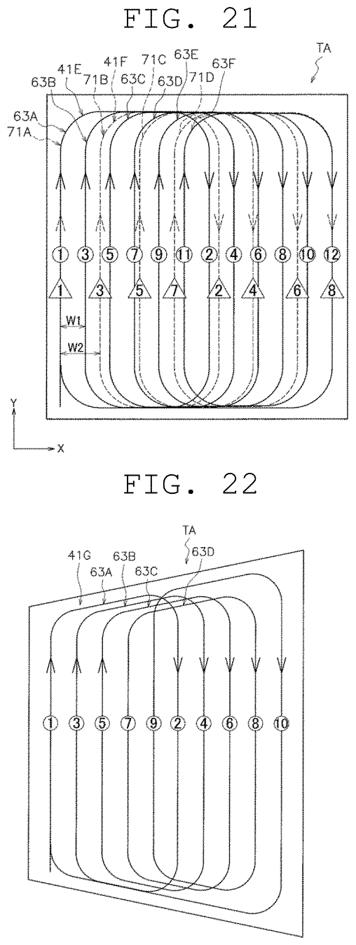

The fourth preferred embodiment will be described with reference to FIG. 21. FIG. 21 is a schematic plan view illustrating the ball collecting route in the traveling region according to the fourth preferred embodiment.

In FIG. 21, the travel order in the main direction route of the respective lap routes is indicated by encircled numbers in the entire fifth ball collecting route 41E. In addition, the travel order in the main direction route of the respective lap routes is indicated by triangle-enclosed numbers in the entire sixth ball collecting route 41F.

As illustrated in FIG. 21, the fifth ball collecting route 41E has the first lap route 63A, the second lap route 63B, the third lap route 63C, the fourth lap route 63D, the fifth lap route 63E, and the sixth lap route 63F.

As illustrated in FIG. 21, the sixth ball collecting route 41F has a first lap route 71A, a second lap route 71B, a third lap route 71C, and a fourth lap route 71D.

In the fifth ball collecting route 41E and the sixth ball collecting route 41F, the main direction routes of the first lap route overlap (circle 1 and triangle 1), and the main direction routes of the last lap route of the fifth ball collecting route 41E and the sixth ball collecting route 41F overlap (circle 12 and triangle 8).

On the other hand, while the number of the lap routes is 6 in the fifth ball collecting route 41E, the number of the lap routes is 4 in the sixth ball collecting route 41F. Accordingly, the sub direction width is different between the both main direction routes. In this preferred embodiment, the sub direction width between the main direction routes of the lap route of the fifth ball collecting route 41E is W1, and the sub direction width between the main direction routes of the lap route of the sixth ball collecting route 41F is W2. W2 is longer than W1. As a result, the main direction routes (circle 2 to circle 11, and triangles 2 to 7) on the sub direction inside of the fifth ball collecting route 41E and the sixth ball collecting route 41F do not overlap one another.

As described above, in the route generation after the first time, the ball collecting route travel schedule generator 57 forms the lap route such that the sub direction width between the lap routes becomes a length different from the sub direction width between the lap routes 3 creased last time. As a result, since the sub direction width between the lap routes is different in each route generation, overlapping travel areas in the ball collecting routes are reduced.

The sub direction width of the main direction routes of the fourth ball collecting route 41D may be shorter than the sub direction width of the main direction routes of the third ball collecting route 41C.

The above change may be formed for each ball collecting route creation, or lap route creation without making the change may be carried out continuously.

Furthermore, although not illustrated in FIG. 21, in each ball collecting route, the turn-around position of the lap route may be shifted as in the first preferred embodiment. For example, the turn-around positions of the lap route may be shifted in the entire respective ball collecting routes, or the turn-around positions of the lap route may be shifted only in some ball collecting routes.

### 5. Fifth Preferred Embodiment

In the first to fourth preferred embodiments, the traveling region TA is a square, but the traveling region TA may have any shape. For example, the traveling region TA may have another shape such as a rectangle and a trapezoid.

Such a preferred embodiment will be described as the fifth preferred embodiment with reference to FIG. 22. FIG. 22 is a schematic plan view illustrating the ball collecting route in the traveling region according to the fifth preferred embodiment.

In this preferred embodiment, the traveling region TA is a trapezoid, and a ball collecting route 41G for the vehicle to travel over the entire area inside the traveling region TA.

In this preferred embodiment, the direction in which the parallel top side and bottom side of the trapezoid extend is the main direction of the lap routes 63A to 63D. The turn-around routes of the lap routes 63A to 63D extend along the both sides of the trapezoid.

### 6. Common Matters of Preferred Embodiments

The first to fifth preferred embodiments have the following configurations and functions in common.

The autonomous travel vehicle (e.g., the ball collecting and discharging machine 1) plans and travels an autonomous traveling route in a designated region (e.g., the traveling region TA), and includes the main body, the route generator, and the travel controller.

The main body (e.g., the main body 11) includes the conveyor (e.g., the travel motor 31).

The route generator (e.g., the ball collecting route travel schedule generator 57) generates an autonomous traveling route (e.g., the ball collecting route 41 or 41A to 41F) along which the autonomous travel vehicle reciprocates the plurality of times in the main direction in the designated region.

The travel controller (e.g., the travel controller 51) moves the main body along the autonomous traveling route by controlling the conveyor.

The route generator generates an autonomous traveling route including the plurality of lap routes (e.g., the lap routes 63A to 63F) coupled together while being shifted in the sub direction intersecting the main direction in the region.

The turn-around positions (e.g., A to C) in the main direction of the respective lap routes include at least one set of turn-around positions shifted from each other.

The autonomous travel vehicle travels on the autonomous traveling route including the plurality of lap routes coupled together while being shifted in the sub direction intersecting the main direction in the region. Therefore, the untraveled area is able to be reduced or prevented even if the autonomous travel vehicle has a large minimum turning radius. Furthermore, since the turn-around positions in the main direction of the respective lap routes include at least one set of turn-around positions shifted from each other, overlapping travel areas at the turn-around positions are reduced.

### 7. Other Preferred Embodiments

While the plurality of preferred embodiments of the present invention have been described above, the present invention is not limited to the above-described preferred embodiments, and various modifications can be made without departing from the scope of the present invention. In particular, the plurality of preferred embodiments and alternative preferred embodiments described in the present description can be combined in any manner as necessary.

Preferred embodiments of the present invention are not limited to a ball collecting and discharging machines, as long as it is an autonomous travel vehicle that performs exhaustive travel in a predetermined region. Preferred embodiments of the present invention can also be applied to, for example, a cleaning machine and a traveling device for amusement rides.

In the first to fifth preferred embodiments, there are three types of turn-around positions, but there is no particular limitation as long as there are two or more types of them.

In the first to fourth preferred embodiments, the width between the pair of main direction routes of each ball collecting route is the same, but different combinations may be provided.

Preferred embodiments of the present invention can be widely applied to an autonomous travel vehicle that performs exhaustive travel.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An autonomous travel vehicle that plans and travels an autonomous traveling route in a designated region, the autonomous travel vehicle comprising:
a main body including a conveyor;
a route generator that generates an autonomous traveling route along which the autonomous travel vehicle reciprocates a plurality of times in a main direction in the designated region; and
a travel controller that moves the main body along the autonomous traveling route by controlling the conveyor; wherein
the route generator generates an autonomous traveling route including a plurality of lap routes coupled together while being shifted in a sub direction intersecting the main direction in the region; and
turn-around positions in the main direction of the lap routes include at least one set of turn-around positions shifted from each other.

2. The autonomous travel vehicle according to claim 1, wherein a turn-around position of a last lap route in the region is on a travel direction innermost side in the main direction among a plurality of turn-around positions.

3. The autonomous travel vehicle according to claim 1, wherein a turn-around position of a first lap route in the region is on a travel direction innermost side in the main direction among a plurality of turn-around positions.

4. The autonomous travel vehicle according to claim 2, wherein a turn-around position of a first lap route in the region is on the travel direction innermost side in the main direction among the plurality of turn-around positions.

5. The autonomous travel vehicle according to claim 1, wherein a shift of the turn-around position is equal to or greater than a wheel width of the conveyor.

6. The autonomous travel vehicle according to claim 2, wherein a shift of the turn-around position is equal to or greater than a wheel width of the conveyor.

7. The autonomous travel vehicle according to claim 3, wherein a shift of the turn-around position is equal to or greater than a wheel width of the conveyor.

8. The autonomous travel vehicle according to claim 4, wherein a shift of the turn-around position is equal to or greater than a wheel width of the conveyor.

9. The autonomous travel vehicle according to claim 1, wherein in route generation after a first time, the route generator sets the main direction of a lap route with respect to the region at an angle different from the main direction of a lap route created last time.

10. The autonomous travel vehicle according to claim 1, wherein in route generation after a first time, the route generator shifts a lap route in the sub direction and/or the main direction with respect to a lap route created last time.

11. The autonomous travel vehicle according to claim 1, wherein in route generation after a first time, the route generator sets a width in the sub direction of a lap route to a length different from a width in the sub direction of a lap route created last time.

12. The autonomous travel vehicle according to claim 1, wherein in order to generate the plurality of lap routes, the route generator:
divides the region into 2N, where N is a natural number, main direction routes in the sub direction so as to be in a long strip shape in the main direction, determines a travel order in the main direction routes as a first, an N+1-th, a second, and an N+2-th; and
sets travel directions of the main direction routes from the first to an N-th and from the N+1-th to a 2N-th so as to be opposite to each other.

13. The autonomous travel vehicle according to claim 9, wherein in order to generate the plurality of lap routes, the route generator:
divides the region into 2N, where N is a natural number, main direction routes in the sub direction so as to be in a long strip shape in the main direction, determines a travel order in the main direction routes as a first, an N+1-th, a second, and an N+2-th; and
sets travel directions of the main direction routes from the first to an N-th and from the N+1-th to a 2N-th so as to be opposite to each other.

14. The autonomous travel vehicle according to claim 10, wherein in order to generate the plurality of lap routes, the route generator:
divides the region into 2N, where N is a natural number, main direction routes in the sub direction so as to be in a long strip shape in the main direction, determines a travel order in the main direction routes as a first, an N+1-th, a second, and an N+2-th; and
sets travel directions of the main direction routes from the first to an N-th and from the N+1-th to a 2N-th so as to be opposite to each other.

15. A route generation method for an autonomous travel vehicle that plans and travels an autonomous traveling route in a designated region, the route generation method comprising:
generating a route along which the autonomous travel vehicle reciprocates a plurality of times in a main direction in the designated region, the route being an autonomous traveling route including a plurality of lap routes coupled together while being shifted in a sub direction; wherein
turn-around positions in a main direction of the respective lap routes include at least one set of turn-around positions shifted from each other.
